(19) United States
(12) Patent Application Publication
(10) Pub. No.: US 2007/0153669 A1
(43) Pub. Date: Jul. 5, 2007

(54) Method for adjusting light diffusing and light focusing capability of an optical element

(76) Inventor: Ping Chuang, Kwei-Shan Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/472,287

(22) Filed: Jun. 22, 2006

(30) Foreign Application Priority Data
Dec. 29, 2005 (TW) 94147286

(51) Int. Cl. G11B 7/24

(52) U.S. Cl. 369/275.4

(57) ABSTRACT

The present invention provides a method of adjusting light diffusing and light focusing capability of an optical element. First, an optical substrate having a first surface area is provided. Then, pluralities of pervious convexes are formed on an optical substrate, wherein the pervious convexes occupy a second surface area on the optical substrate. Diffusing effect of the optical element can be lowered/improved by increasing/decreasing an arrangement regularity of the pervious convexes. Diffusing effect enlarging/reducing the size of the optical element can also be lowered/increased by enlarging/reducing the size of pervious convexes. The focusing effects of the optical element can be improved/lowered by increasing/decreasing the ratio of the second surface area and the first surface area.

### RELATED APPLICATIONS

The present application is based on, and claims priority from, Taiwan Application Serial Number 94147286, filed Dec. 29, 2005, the disclosure of which is hereby incorporated by reference herein in its entirety.

### BACKGROUND

1. Field of Invention

The present invention relates to an optical element. More particularly, the present invention relates to a method for adjusting light diffusing and light focusing capability of an optical element.

2. Description of Related Art

Planar light sources with uniform brightness are hard to generate because of manufacturing limitations of light sources and light emitting devices such as light emitting diodes (LED), which are point light sources, and cold cathode fluorescent lamps (CCFL), which are linear light sources. When a product requires a planar light source, an optical element that can diffuse light is conventionally present in the product so as to diffuse the light emitted from the light sources. In addition, the product should also comprise another focusing element so that the light can be focused on the front.

A typical example is a back light module of a liquid crystal display (LCD). FIG. 1 is a cross-section schematic diagram showing a traditional back light module of a liquid crystal display. In FIG. 1, because liquid crystal cannot be self-illuminated, a light source 104 is added to the back of a LCD panel 102 so that the LCD images can be displayed. Generally, a back light module 100 is used in the LCD. First, a light emitted from the light source 104 is guided into a light guide plate 106. After the light is reflected by a reflector 108, the light passes through a diffuser plate 110, which diffuses the light. Then, the light passes through an enhancer plate 112, which focuses the light. After the light passes through the diffuser plate 110 and the enhancer plate 112, it would pass through and illuminate the LCD panel 102.

When several optical elements are used to homogenize and focus light, partial light is absorbed by the optical elements during light transmission, which results in inefficient utilization of the light. However, if an optical element can both diffuse and focus light, the light absorbed by the optical elements will be reduced, but the light diffusing effect and light focusing capability of the optical element cannot be individually adjusted according to the demands and thus the optical element has poor utilization. The term “light diffusion” means the percentage of scattered light compared to the total transmitted light.

Therefore, there is a need for reducing the number of optical elements and obtaining light diffusing effect and focusing light effect of an optical element according to demands without decreasing the brightness to resolve the problems mentioned above.

### SUMMARY

In one aspect, this present invention provides an optical element that can achieve the effect that conventionally requires two optical elements to achieve.

In another aspect, this present invention provides methods for adjusting light diffusing and light focusing capability of an optical element by changing the design of the optical element according to demands to obtain desired light diffusing effect and light focusing effect.

In accordance with the foregoing and other aspects of the present invention, the present invention provides a method for adjusting light diffusing and light focusing capability of an optical element, wherein the optical element design is changed according to the demands of the display device to achieve the desired light diffusing effect and light focusing effect. First, an optical substrate having a first surface area is provided. Then, a plurality of pervious convexes are formed on the optical substrate. The pervious convexes occupy a second surface area on the optical substrate. An arrangement regularity of the pervious convexes can be increased/decreased to lower/improve the diffusing effect of the optical element and the ratio of the second surface area and the first surface area can be increased/decreased to improve/lower the focusing effect of the optical element.

According to one preferred embodiment of the present invention, the distance between two neighboring pervious convex on the optical substrate can be changed to increase/decrease the diffusing and focusing effects of the optical element.

According to another preferred embodiment of the present invention, arrangement regularity or the sizes of the pervious convexes can be changed to increase or decrease the diffusing effect of the optical element while the ratio of the second surface area and the first surface area remains unchanged.

According to yet another preferred embodiment of the present invention, arrangement regularity or the sizes of the pervious convexes can be adjusted to maintain the diffusing effect of the optical element while the ratio of the second surface area and the first surface area is reduced.

Thus, the present invention provides a method to adjust the diffusing and focusing light capabilities of an optical element, wherein the optical element design is changed according to the demands of the display device to achieve the desired light diffusing effect and light focusing effect. The method for changing the optical element design comprises adjusting sizes, arrangement regularity or areas of the pervious convexes occupied on the optical substrate to obtain the desired light diffusing effect and light focusing effect. Moreover, the optical element of the present invention can achieve the effects that conventionally required two optical elements. That is, the optical element of the present invention has capabilities of both diffusing light and focusing light. Furthermore, the optical element of the present invention not only can turn uneven incident light into planar light sources with uniform brightness, but can also increase the front-side brightness.

### BRIEF DESCRIPTION OF THE DRAWINGS

The invention can be more fully understood by reading the following detailed description of the preferred embodiment, with reference made to the accompanying drawings as follows:

FIG. 1 is a cross-section schematic diagram showing a traditional back light module of a liquid crystal display.

FIG. 2 is a top view diagram showing an optical element.

FIG. 3 is a cross-section schematic diagram along the I-I′ line in FIG. 2.

FIG. 4 to FIG. 9 are top view diagrams showing an optical element according to different embodiments of the present invention.

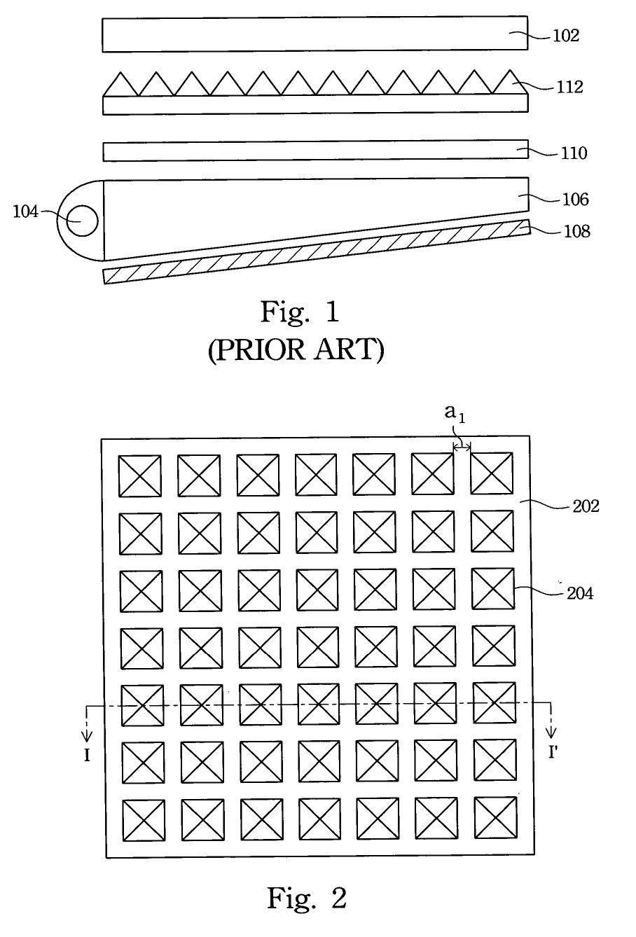

### DESCRIPTION OF THE PREFERRED EMBODIMENTS

The method of the present invention can reduce the number of required optical elements, and adjust the light diffusing and the light focusing effects of the optical element according to demands. The embodiments provided herein are for description of the use and manufacture of the present invention and should not be used to limit the scope of the claims.

FIG. 2 is a top view diagram showing an optical element. In FIG. 2, an optical element 200 comprises an optical substrate 202 and pervious convexes 204. The optical substrate 202 has a first surface area and the pervious convexes 204 occupy a second surface area on the optical substrate 202. The distance between two pervious convexes 204 is a₁. Preferred materials for the optical element 200 mentioned above are those with high visible light transparency, such as glass, polyester and the like. The scale of the pervious convexes 204 is smaller than micro-scale, preferably 2-20 μm in size. According to the preferred embodiment of the present invention, the pervious convexes 204 are more preferably 3-10 μm in size.

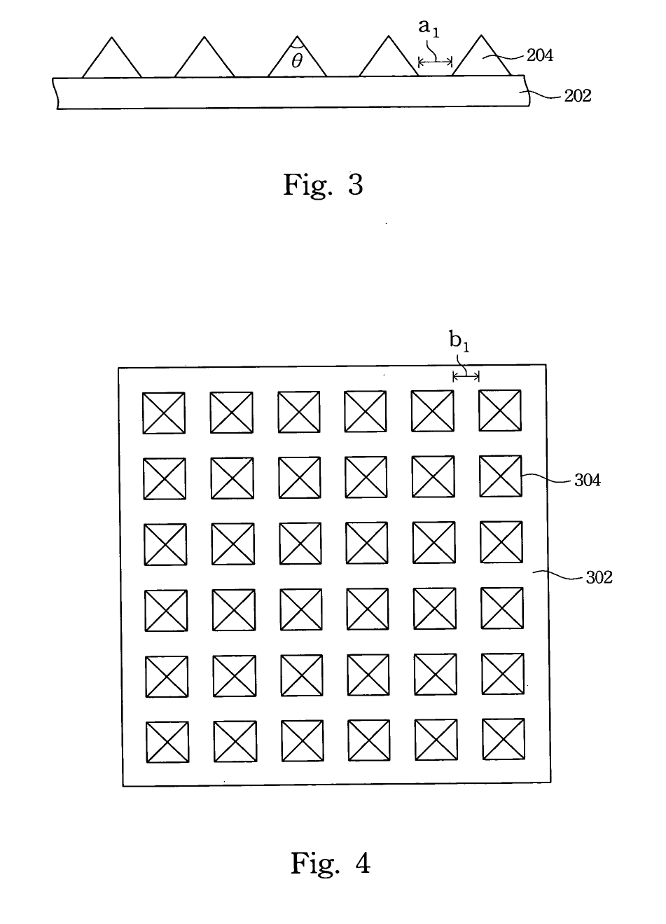

FIG. 3 is a cross-section schematic diagram along the I-I′ line in FIG. 2. In FIG. 2 and FIG. 3, the pervious convexes 204 are pyramid structures having the same size and in a regular arrangement. Each of the pyramid structures has a pointed tip on the top. An angle θ of the pointed tip on the top is preferably between 65° and 115°. Alternatively, the pervious convexes 204 can have tops with a blunted surface according to the demands.

The scale of the pervious convexes 204 are smaller than micro-scale so that the optical element 200 can diffuse light, and the pervious convexes 204 are pyramid structures so that the optical element 200 can focus light. Thus, the optical element of the present invention can achieve the effect that conventionally required two optical elements to achieve. That is, the optical element of the present invention can both diffuse and focus light. The optical element of the present invention shows light diffusing effect between 17% and 55% preferably, and light focusing effect less than 200% preferably.

The present invention provides a method to adjust light diffusing and light focusing capability of an optical element, wherein the optical element design is changed according to the demands of the display device to achieve the desired light diffusing effect and/or light focusing light effect. The following description describes different methods for adjusting the optical element design to obtain the desired light diffusing effect and/or light focusing effect according to embodiments of the present invention.

FIG. 4 is a top view diagram showing an optical element according to one embodiment of the present invention. In FIG. 2 and FIG. 4, the pervious convexes 304 in FIG. 4 have the same size as the pervious convexes 204 in FIG. 2. However, the distance b₁ between two pervious convexes 304 is greater than the distance a₁, between two neighboring pervious convexes 204. That is, the surface area on the optical substrate 302 occupied by the pervious convexes 304 in FIG. 4 is smaller than the surface area on the optical substrate 202 occupied by the pervious convexes 204 in FIG. 2. The optical element 200 in FIG. 2 and the optical element 300 in FIG. 4 are subjected to the light diffusing test and the light focusing test. The results show that the light diffusing effect and the light focusing effect of the optical element 300 in FIG. 4 are less than the light diffusing effect and the focusing light effect of the optical element 200 in FIG. 2.

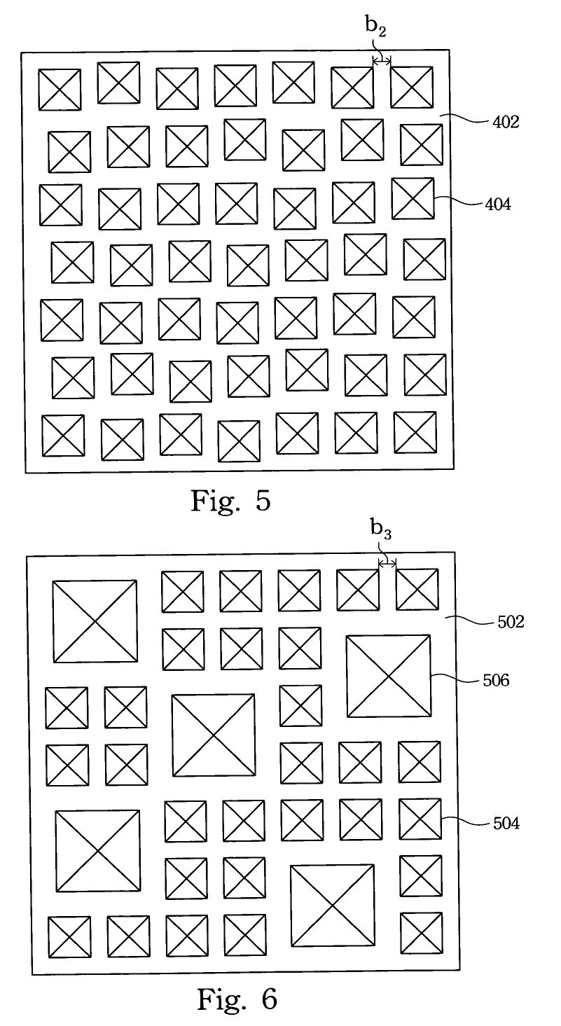

FIG. 5 is a top view diagram showing an optical element according to another embodiment of the present invention. In FIG. 2 and FIG. 5, the pervious convexes 404 in FIG. 5 have the same size as the pervious convexes 204 in FIG. 2, and the distance b₂ between two neighboring pervious convexes 404 is the same as the distance a₁, between two neighboring pervious convexes 204. However, the pervious convexes 404 in FIG. 5 are arranged more irregularly than the pervious convexes 204 in FIG. 2. The optical element 200 in FIG. 2 and the optical element 400 in FIG. 5 are subjected to the light diffusing test and the light focusing test. The results show that the light diffusing effect of the optical element 400 in FIG. 5 is greater than the light diffusing effect of the optical element 200 in FIG. 2, and the light focusing effect of the optical element 400 in FIG. 5 is the same as the light focusing effect of the optical element 200 in FIG. 2.

The results of the optical element 200, 300 and 400 respectively in FIG. 2, FIG. 4 and FIG. 5 are analyzed. The results show that the optical element having the same pervious convex density, such as the optical element 200 in FIG. 2 and the optical element 400 in FIG. 5, have the same light focusing effect. The optical element has lower pervious convex density, such as the optical element 300 in FIG. 4, the light focusing effect of the optical element is reduced. In FIG. 2 and FIG. 5, the optical element 400, having a more irregular arrangement than the optical element 200, has higher light diffusing effect. Therefore, the arrangement regularity of the optical element can be changed to increase or decrease the light focusing effect of the optical element.

FIG. 6 is a top view diagram showing an optical element according to one embodiment of the present invention. In FIG. 6, an optical substrate 502 comprises first pervious convexes 504 and second pervious convexes 506. The first pervious convexes 504 are smaller than the second pervious convexes 506. In FIG. 2 and FIG. 6, the surface area on the optical substrate 502 occupied by the first pervious convexes 504 and the second pervious convexes 506 in FIG. 6 is the same as the surface area on the optical substrate 202 occupied by the pervious convexes 204 in FIG. 2. The distance b₃ between two neighboring pervious convexes 504, 506 is the same as the distance a₁ between two neighboring pervious convexes 204. However, the pervious convexes 504, 506 on the optical substrate 502 in FIG. 6 have different sizes, in comparison with FIG. 2. The optical element 200 in FIG. 2 and the optical element 500 in FIG. 6 are subjected to the light diffusing test and the light focusing test. The results show that the light diffusing effect of the optical element 500 in FIG. 6 is greater than the light diffusing effect of the optical element 200 in FIG. 2, but the light focusing effect of the optical element 500 in FIG. 6 is the same as the light focusing effect of the optical element 200 in FIG. 2.

Thus, the results of the optical elements 200, 400 and 500 respectively in FIG. 2, FIG. 5 and FIG. 6 are analyzed, which show that the light diffusing effect of the optical element can be enhanced or reduced by changing the arrangement regularity or sizes of the pervious convexes while the surface area on the optical substrate occupied by the pervious convexes remains unchanged.

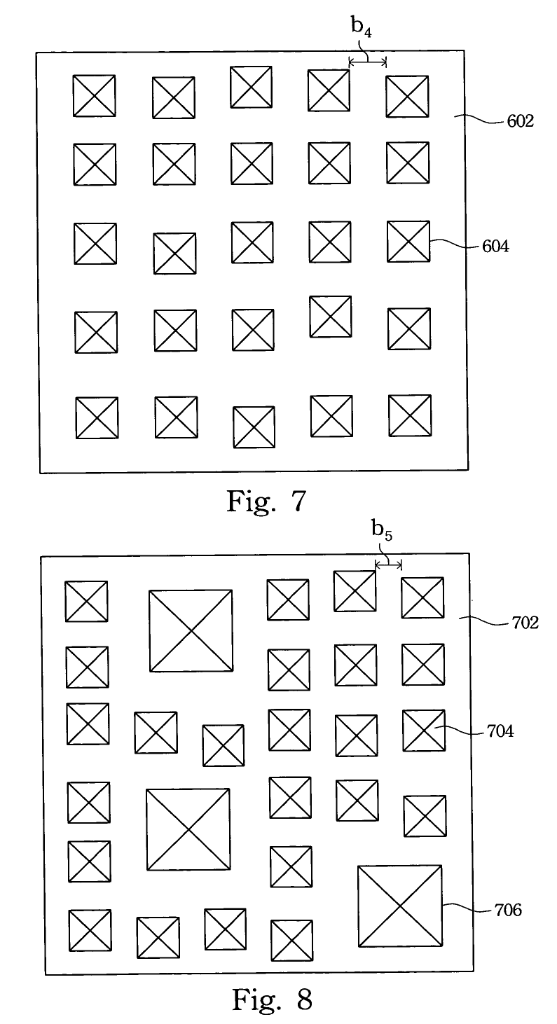

FIG. 7 is a top view diagram showing an optical element according to one embodiment of the present invention. In FIG. 2 and FIG. 7, the pervious convexes 604 in FIG. 7 have the same size as the pervious convexes 204 in FIG. 2. However, the distance b₄ between two neighboring pervious convexes 604 is larger than the distance a₁, between two neighboring pervious convexes 204, and the pervious convexes 604 in FIG. 7 are arranged more irregularly than the pervious convexes 204 in FIG. 2. The optical element 200 in FIG. 2 and the optical element 600 in FIG. 7 are subjected to the light diffusing test and the light focusing test. The results show that the light focusing effect of the optical element 600 are smaller than the optical element 200 in FIG. 2, but the light diffusing effect of the optical element 600 in FIG. 7 is the same as the optical element 200 in FIG. 2. From the results above, the light focusing effect and light diffusing effect of the optical element are decreased by decreasing the pervious convexes occupy a second surface area on the optical substrate. The arrangement of the pervious convexes can be adjusted to improve the light diffusing effect of the optical element until the light diffusing effect of the optical element 600 is the same as the optical element 200 in FIG. 2.

FIG. 8 is a top view diagram showing an optical element according to another embodiment of the present invention. In FIG. 8, an optical substrate 702 comprises a first pervious convexes 704 and a second pervious convexes 706. The first pervious convexes 704 are smaller than the second pervious convexes 706. In FIG. 2 and FIG. 8, the distance b₅ between two neighboring pervious convexes 704, 706 in FIG. 8 is greater than the distance a₁, between two neighboring pervious convexes 204 in FIG. 2. That is, the surface area on the optical substrate 702 occupied by the pervious convexes 704, 706 in FIG. 8 is smaller than the surface area on the optical substrate 202 occupied by the pervious convexes 204 in FIG. 2. The pervious convexes 704, 706 in FIG. 8 are arranged more irregularly than the pervious convexes 204 in FIG. 2. The optical element 200 in FIG. 2 and the optical element 700 in FIG. 8 are subjected to the light diffusing test and the light focusing test. The results show that the light focusing effect of the optical element 700 in FIG. 8 is less than the optical element 200 in FIG. 2, but the light diffusing effect of the optical element 700 in FIG. 8 is the same as the optical element 200 in FIG. 2.

The results of the optical elements 200, 300, 600 and 700 respectively in FIG. 2, FIG. 4, FIG. 7 and FIG. 8 are analyzed. The results show that density of the pervious convexes is lower and surface area on the optical substrate occupied by the pervious convexes is reduced, such as the optical element 200 in FIG. 2 and the optical element 300 in FIG. 4, the light focusing effect and the light diffusing effect of the optical element are reduced. The arrangement regularity of the optical element can be changed, such as in comparison with FIG. 2 and FIG. 7, or the arrangement regularity and sizes of the optical element can be changed simultaneously, such as in comparison with FIG. 2 and FIG. 8, to improve the light diffusing effect of the optical element until the light diffusing effect of the optical element 700 in FIG. 8 is the same as the optical element 200 in FIG. 2.

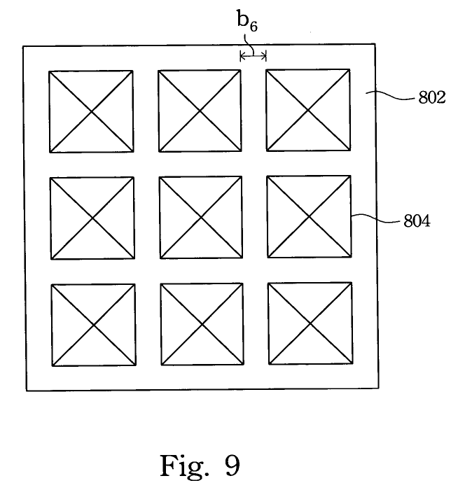

FIG. 9 is a top view diagram showing an optical element according to another embodiment of the present invention. In FIG. 4 and FIG. 9, a surface area occupied by the first pervious convexes 804 on the optical substrate 802 in FIG. 9 is the same as the surface area occupied by the pervious convexes 304 in FIG. 4 on the optical substrate 302. The distance b₆ between two neighboring pervious convexes 804 is the same as the distance b₁, between two neighboring pervious convexes 304 in FIG. 4. However, the pervious convexes 804 on the optical substrate 802 in FIG. 9 have greater sizes than the pervious convexes 304 in FIG. 4. The optical element 300 in FIG. 4 and the optical element 800 in FIG. 9 are subjected to the light diffusing test and the light focusing test. The results show that the light focusing effect of the optical element 800 in FIG. 9 is the same as the optical element 300 in FIG. 4, but the light diffusing effect of the optical element 800 in FIG. 9 is less than the optical element 300 in FIG. 4.

The results are listed in Table 1 showing the relation between different sizes of the pervious convexes and the light diffusing effect thereof. From the results of FIG. 4, FIG. 9 and Table 1, when the surface area occupied by the pervious convexes on the optical substrate is unchanged, the light focusing effect of the optical element is the same. The light focusing effect of the optical element can be increased or decreased by decrease or increase the sizes of the pervious convexes can be increased or reduced to decrease or increase.

TABLE 1
Different sizes of pervious convexes and
light diffusing effect of optical element

| | Light diffusing effect of optical |
|---|---|
| Sizes of pervious convexes (microns) | element (%) |
| 2 | 55 |
| 5 | 29 |
| 10 | 24 |
| 20 | 17 |

Thus, the present invention provides a method to adjust the light diffusing and light focusing capabilities of an optical element, wherein the optical element design is changed according to the demands of the display device to achieve the desired light diffusing effect and light focusing effect. The method for changing the optical element design comprises adjusting sizes, arrangement regularity or areas of the pervious convexes occupied on the optical substrate to obtain the desired light diffusing effect and the light focusing effect. Moreover, the optical element of the present invention can achieve the effect that conventionally required two optical elements. That is, the optical element of the present invention has capabilities of both diffusing light and focusing light. Furthermore, the optical element of the present invention cannot turn uneven incident light into planar light sources with uniform brightness, but can also increase the forward brightness.

The preferred embodiments of the present invention described above should not be regarded as limitations to the present invention. It will be apparent to those skilled in the art that various modifications and variations can be made to the present invention without departing from the scope or spirit of the invention. The scope of the present invention is as defined in the appended claims.

What is claimed is:

1. A method of adjusting the light diffusing and light focusing capability of an optical element, the method comprising:
providing an optical substrate having a first surface area; and
forming a plurality of pervious convexes on the optical substrate, wherein the pervious convexes occupy a second surface area on the optical substrate, and an arrangement regularity of the pervious convexes can be increased/decreased to lower/improve the diffusing effect of the optical element and ratio of the second surface area and the first surface area can be increased/decreased to improve/lower focusing effect of the optical element.

2. The method of adjusting the light diffusing and light focusing capability of an optical element of claim 1, wherein the pervious convexes have the same size.

3. The method of adjusting light diffusing and light focusing capability of an optical element of claim 1, wherein the pervious convexes have different sizes.

4. The method of adjusting light diffusing and light focusing capability of an optical element of claim 1, wherein scale of the pervious convexes are smaller than micro-scale.

5. The method of adjusting light diffusing and light focusing capability of an optical element of claim 1, wherein the pervious convexes are pyramid structures.

6. The method of adjusting light diffusing and light focusing capability of an optical element of claim 5, wherein the pervious convexes have tops with a blunted surface.

7. A method of adjusting light diffusing and light focusing capability of an optical element, the method comprising:
providing an optical substrate having a first surface area; and
forming a plurality of first pervious convexes and a plurality of second pervious convexes on the optical substrate, wherein the first pervious convexes and the second pervious convexes have different sizes and occupy a second surface area on the optical substrate, and an arrangement regularity of the first pervious convexes and the second pervious convexes can be increased/decreased to lower/improve the light diffusing effects of the optical element and the ratio of the second surface area and the first surface area can be increased/decreased to improve/lower the light focusing effect of the optical element.

8. The method of adjusting light diffusing and light focusing capability of an optical element of claim 7, wherein the first pervious convexes and the second pervious convexes are arranged irregularly.

9. The method of adjusting the light diffusing and light focusing capability of an optical element of claim 8, wherein a part of the first pervious convexes are arranged together.

10. The method of adjusting the light diffusing and light focusing capability of an optical element of claim 7, wherein sizes of the first pervious convexes and the second pervious convexes are smaller than micro-scale.

11. The method of adjusting light diffusing and light focusing capability of an optical element of claim 7, wherein the first pervious convexes and the second pervious convexes are pyramid structures.

12. The method of adjusting light diffusing and light focusing capability of an optical element of claim 11, wherein the first pervious convexes and the second pervious convexes have tops with a blunted surface.

13. A method of adjusting light diffusing and light focusing capability of an optical element, the method comprising:
providing an optical substrate having a first surface area; and
forming a plurality of pervious convexes on the optical substrate, wherein the pervious convexes have a second surface area on the optical substrate and sizes of the pervious convexes can be increased/decreased to lower/improve focusing effect of the optical element.

14. The method of adjusting light diffusing and light focusing capability of an optical element of claim 13, wherein the pervious convexes have the same size.

15. The method of adjusting light diffusing and light focusing capability of an optical element of claim 13, wherein the pervious convexes have different sizes.

16. The method of adjusting light diffusing and light focusing capability of an optical element of claim 13, wherein scale of the pervious convexes are less than micro-scale.

17. The method of adjusting light diffusing and light focusing capability of an optical element of claim 13, wherein the pervious convexes are pyramid structures.

18. The method of adjusting light diffusing and light focusing capability of an optical element of claim 17, wherein the pervious convexes have tops with a blunted surface.
